(19) United States
(12) Patent Application Publication
(10) Pub. No.: US 2015/0326641 A1
(43) Pub. Date: Nov. 12, 2015

(54) MOBILE TO MOBILE REMOTE CONTROL

(71) Applicant: W2G, LLC, Dallas, TX (US)

(72) Inventors: Michael Seeley, Irving, TX (US); Nancy L. Albertini, Dallas, TX (US); Stephen J. Metzger, Dallas, TX (US)

(73) Assignee: W2G, LLC, Dallas, TX (US)

(21) Appl. No.: 14/272,231

(22) Filed: May 7, 2014

(51) Int. Cl. H04L 29/08; H04W 48/08; G06F 21/44

(52) U.S. Cl. CPC H04L 67/025; G06F 21/44; H04W 48/08; G06F 2221/2129

(57) ABSTRACT

In various example embodiments, systems and methods for mobile to mobile remote control are presented. A control request may be received at a client device from a control device. The control device and the client device may be in communication with a network. The client device may determine an authorization for the control device in response to receiving the control request. Based on the determined authorization, a data link may be established between the client device and the control device using a control device identifier. The data link may allow the exchange of information between the client device and the control device without an intermediate network node. The client device may receive a command request from the control device via the data link. The command request may be initiated by a control user of the control device.

### TECHNICAL FIELD

Embodiments of the present disclosure relate generally to mobile devices, and more particularly, but not by way of limitation, to mobile to mobile remote control.

### BACKGROUND

In recent years there has been a proliferation of mobile devices. A wide variety of mobile devices, operating systems (e.g., iOS™, Android™, Windows® Phone), and mobile software have become available to consumers. These trends combined with the near ubiquity of wireless networks provide consumers with access to information and software at virtually any physical location. Such a variety of mobile devices and software, and an ever-increasing reliance upon them, has amplified the complexity and importance of training, maintaining, and resolving technical issues with such devices. Traditionally, these tasks have been performed while physically operating the mobile device.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to example embodiments.

FIG. 2 is a block diagram illustrating an example embodiment of a remote control system, according to example embodiments.

FIG. 3 is a block diagram illustrating an example embodiment of a remote client system, according to example embodiments.

FIG. 4 is a flow diagram illustrating an example method for remote control, according to example embodiments.

FIG. 5 is a flow diagram illustrating communication between devices, according to example embodiments.

FIG. 6 illustrates example devices performing remote control, according to example embodiments.

FIGS. 7A, 7B and 7C are flow diagrams illustrating various example remote control tasks, according to example embodiments.

FIGS. 8 and 9 are flow diagrams illustrating example methods for communicating a user interface representation, according to example embodiments.

FIG. 10 is a flow diagram illustrating an example method for establishing a data link, according to example embodiments.

FIG. 11 illustrates an example user interface for presenting various example remote control options, according to example embodiments.

FIG. 12 illustrates an example user interface for presenting a trusted connections list, according to example embodiments.

FIG. 13 illustrates an example user interface for presenting a connection notification, according to example embodiments.

FIG. 14 is a block diagram illustrating a mobile device, according to example embodiments.

FIG. 15 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described in detail herein are systems and methods for mobile to mobile remote control. In an example embodiment, a control device and a client device may be in communication with a cellular network. A control request may be initiated by a user of the control device and may be received at the client device. In response to receiving the control request, the client device may determine an authorization for the control device. Based on the determined authorization, the client device may establish a data link via the cellular network between the client device and the control device using a control device identifier. The data link may be a peer-to-peer connection allowing the exchange of information between the client device and the control device without an intermediate network node. Subsequent to establishing the data link, a control user (e.g., user of the control device) may initiate a command request at the control device. The command request may be communicated via the data link and received at the client device. The client device may perform a task based on the command request. The task may include a wide variety of tasks. For instance, the task may be accessing a client device resource (e.g., a stored file, data or signals from the client device, externally coupled devices, and so on), providing input to a client user interface (e.g., a touch or gesture), and so forth.

In further example embodiments, the client device may capture a current state of a client user interface (e.g., a user interface currently being displayed by the client device). A user interface representation corresponding to the current state of the client user interface may be generated and communicated to the control device. For example, the user interface representation may be a compact representation of the current state of the client user interface. The control device may present to the control user an interpreted user interface based on the user interface representation. In some example embodiments, the client device may capture the current state of the client user interface and communicate the user interface representation to the control device at a periodic rate. In other example embodiments, the user interface representation may be communicated based on a change in the client user interface. Various schemes may be employed to reduce the memory burden and network usage of communicating the client user interface representation to the control device.

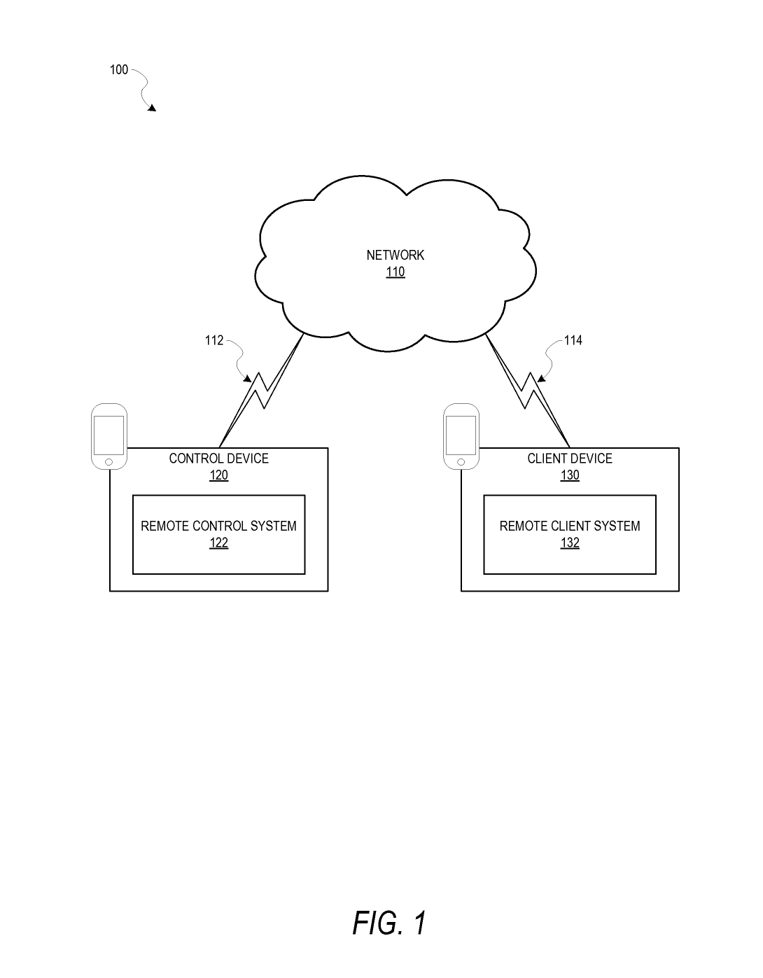

With reference to FIG. 1, an example embodiment of a high-level networked architecture 100 is shown. In example embodiments, a control device 120 may be coupled to a client device 130 via a network 110. For example, connections 112 and 114 may be Code Division Multiple Access (CDMA) connections, a Global System for Mobile communications (GSM) connections, or other type of cellular connections. The connections 112 and 114 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Worldwide Interoperability for Microwave Access (WiMAX), Long Term Evolution (LTE) standard, other long range protocols, or other data transfer technology. When such technology is employed, the network 110 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks). The control device 120 and the client device 130 may be coupled via the connections 112 and 114 respectively. The connections 112 and 114 may be wireless connections allowing for wireless coupling of the control device 120 and the client device 130 from distant physical locations. In some example embodiments, one or more portions of the network 110 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The control device 120 and the client device 130 may comprise, but are not limited to, mobile phones, portable digital assistants (PDAs), smart phones, tablets, smart appliances, smart homes, smart watches, other smart devices, microprocessor-based or programmable consumer electronics, portable game consoles, or any other communication device that may be coupled to another device via the cellular network 110. In some embodiments, the client device 130 may comprise a display module (not shown) to display information (e.g., in the form of user interfaces). In further embodiments, the control device 120 and the client device 130 may comprise one or more of touch screens, accelerometers, gyroscopes, biometric sensors, camera sensors, microphones, Global Positioning System (GPS) components, and so forth. In various example embodiments, the control device 120 and the client device 130 may be operable to execute various applications such as a web browser, music players, camera applications, and so forth.

In an example embodiment, the control device 120 may include a remote control system 122. The remote control system 122 may provide functionality to establish a data link between the control device 120 and the client device 130 and communicate command requests to the client device 130. For example, the control user of the control device 120 may initiate a command request at the control device 120. The control device 120 may then communicate the command request to the client device 130 using the remote control system 122. Although one control device 120 is shown in FIG. 1, more than one control device 120 may be included in the networked architecture 100.

In an example embodiment, the client device 130 may include a remote client system 132. The remote client system 132 may provide functionality to establish the data link between the control device 120 and the client device 130 and receive command requests from the control device 120. For example, the client device 130 may receive the command request from the control device 120 and perform the task based on the received command request using the remote client system 132. Although one client device 130 is shown in FIG. 1, more than one client device 130 may be included in the networked architecture 100.

The remote control system 122 and the remote client system 132 may be in an example form of an application executing on a mobile device. For example, the remote control system 122 and the remote client system 132 may be mobile software running on a mobile operating system such as iOS™, Android™, Windows® Phone, and other mobile operating systems. The remote control system 122 and the remote client system 132 may invoke various Application Programming Interfaces (APIs) provided by the mobile operating system to facilitate functionality described herein.

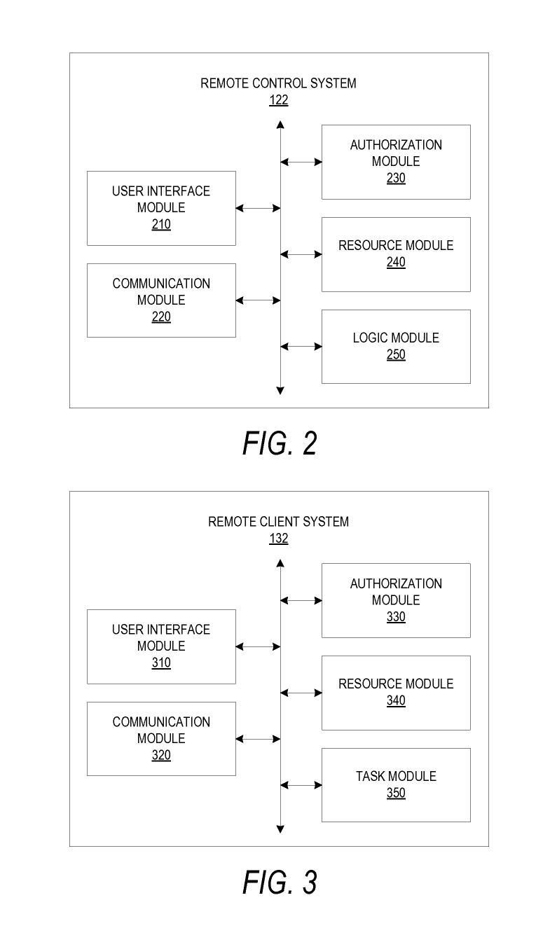

FIG. 2 is a block diagram of a remote control system 122, which may provide a number of functions to establish the data link with the client device 130 and communicate various command requests to the client device 130. In an example embodiment, the remote control system 122 may include a user interface module 210, a communication module 220, an authorization module 230, a resource module 240, and a logic module 250. All of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

The user interface module 210 may provide various user interface functionality operable to interactively present and receive information from the control user of the control device 120. For example, the user interface module 210 may provide a user interface configured to receive the command request from the control user. Information may be presented using a variety of means including visually displaying information and using other device outputs (e.g., audio, tactile). Similarly, information may be received via a number of different means including alphanumeric input or other device input (e.g., one or more touch screen, camera, tactile sensors, light sensors, infrared sensors, biometric sensors, microphone, gyroscope, accelerometer, other sensors). It will be appreciated that the user interface module 210 may provide many other user interfaces to facilitate functionality described herein. Presenting is intended to include communicating information to another device with functionality operable to perform presentation using the communicated information. Interactively presenting is intended to include the exchange of information from a device and a user via a user interface.

The communication module 220 may perform various communication functions including network communication such as establishing the data link between the control device 120 and the client device 130 via the cellular network and communicating various command requests to the client device 130. The communication module 220 may communicate a variety of information via the cellular network to facilitate the functionality described herein. In addition, the communication module 220 may also communicate information via Short Message Service (SMS), Multimedia Messaging Service (MMS), Enhanced Messaging Service (EMS), other messaging modalities, voice calls, and other wireless means to provide communication functionality. In some example embodiments, the communication module 220 may communicate with application servers and third party servers to exchange a variety of information.

The authorization module 230 may provide various authorization functionalities. For example, the authorization module 230 may receive authorization data (e.g., a password) from the control user and determine whether the control user is authorized to perform various actions. The authorization module 230 may be used to authorize a wide variety of functionality and actions described herein.

The resource module 240 may provide various resource functionalities associated with the control device 120. For example, various resources of the control device 120 may be accessed by the resource module 240. The resources that may be accessed by the resource module 240 may include stored data (e.g., music files, images files, stored device sensor data, contact lists, device settings, device maintenance data), device sensors (e.g., accelerometers, gyroscopes, biometric sensors, camera sensors, microphones, GPS components), signals from the device sensors, externally coupled sensors, externally coupled devices, communication components (e.g., near field communication (NFC) components such as Bluetooth), and other resources.

The logic module 250 may provide various logic functions to facilitate the operation of the remote control system 122. For example, logic to analyze user inputs received by the user interface module 210 and logic to determine actions based on the user inputs may be provided by the logic module 250. The logic module 250 may perform a wide variety of application logic.

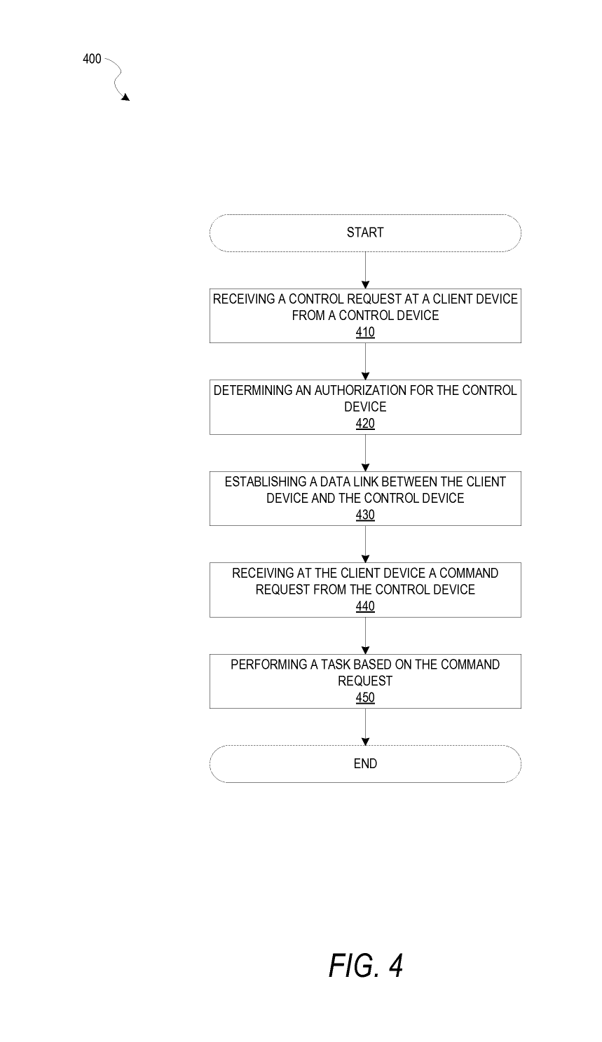

FIG. 3 is a block diagram of a remote client system 132, which may provide a number of functions to establish the data link with the control device 120 and receive various command requests from the control device 120. In an example embodiment, the remote client system 132 may include a user interface module 310, a communication module 320, an authorization module 330, a resource module 340, and a task module 350. All of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

The user interface module 310, similar to the user interface module 210, may provide various user interface functionality operable to interactively present and receive information from the control user using the control device 120. For example, the user interface module 310 may provide a user interface configured to provide an option to allow the authorization of the control device 120 to the client user (e.g., user of the client device 130). Information may be presented using a variety of means including visually displaying information and using other device outputs (e.g., audio, tactile). Similarly, information may be received via a number of different means including alphanumeric input or other device input (e.g., one or more touch screen, camera, tactile sensors, light sensors, infrared sensors, biometric sensors, microphone, gyroscope, accelerometer, other sensors). It will be appreciated that the user interface module 310 may provide many other user interfaces to facilitate functionality described herein.

The communication module 320, similar to the communication module 220, may perform various communication functions including network communication such as establishing the data link between the control device 120 and the client device 130 via the cellular network 110 and receiving various command requests from the control device 120. The communication module 320 may communicate a variety of information via the cellular network to facilitate the functionality described herein. In addition, the communication module 320 may also communicate information via SMS, MMS, EMS, other messaging modalities, voice calls, and other wireless means to provide communication functionality. In some example embodiments, the communication module 320 may communicate with application servers and third party servers to exchange a variety of information.

The authorization module 330 may provide various authorization functionalities. For example, the authorization module 330 may determine whether the control device 120 is authorized to perform various actions. The authorization module 330 may be used to authorize a wide variety of functionality and actions described herein.

The resource module 340 may provide various resource functionalities associated with the client device 130. For example, various resources of the client device 130 may be accessed by the resource module 340. The resources that may be accessed by the resource module 340 may include stored data (e.g., music files, images files, stored device sensor data, contact lists, device settings, device maintenance data), device sensors (e.g., accelerometers, gyroscopes, biometric sensors, camera sensors, microphones, GPS components), signals from the device sensors, externally coupled sensors, externally coupled devices, communication components (e.g., NFC components such as Bluetooth), and other resources.

The task module 350 may perform various tasks associated with the client device 130. For example, the task module 350 may interpret the command request received from the control device 120 to determine an interpreted command and execute the interpreted command at the client device 130. Many other tasks associated with the client device 130 may be performed by the task module 350.

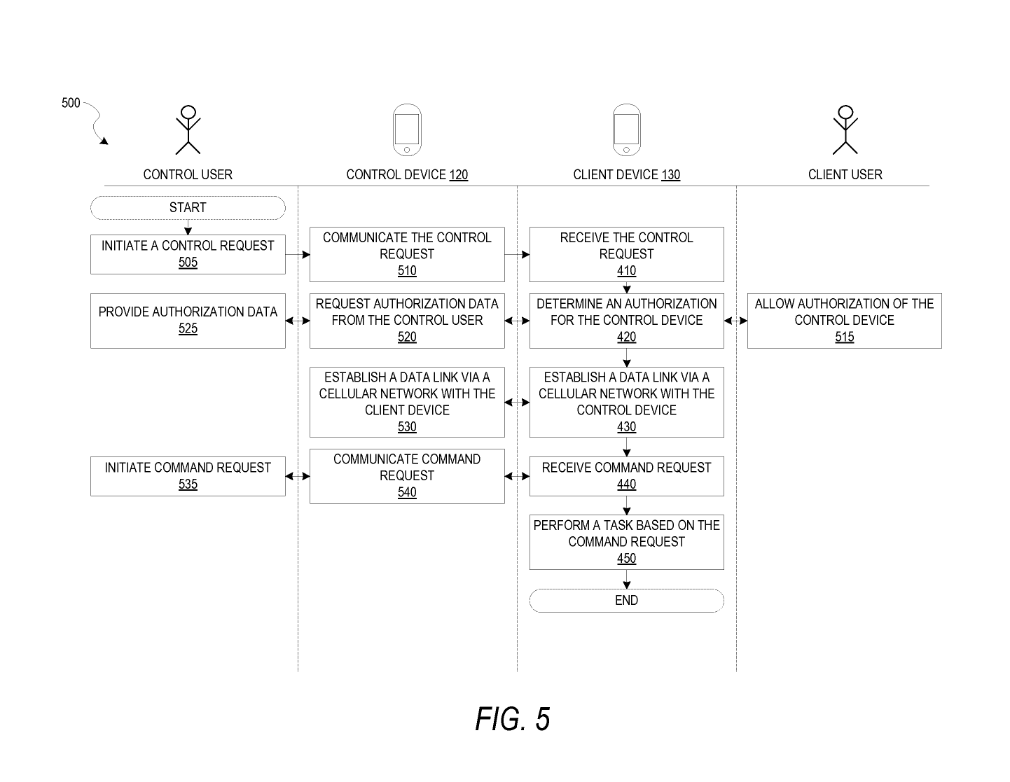

FIG. 4 is a flow diagram illustrating an example method 400 for remote control, according to example embodiments. The operations of the method 400 may be performed by components of the remote client system 132. At operation 410, the communication module 320 may receive the control request at the client device 130 from the control device 120. The control request may be received via a number of different means. For example, the control request may be received via SMS, MMS, EMS, and other messaging modalities (herein referred to collectively as text messages). In other examples, the control request may be received via a voice call, via a message communicated through the cellular network, or other communication means.

In various example embodiments, the control request may include a control device identifier that may identify the control device 120. For instance, the control device identifier may be an Internet Protocol (IP) address, Media Access Control (MAC) address, other unique identifies, an International Mobile Station Equipment Identity (IMEI), a Mobile Equipment Identifier (MEID), other mobile identifiers, or other identifiers. In some example embodiments, the control device identifier may be a telephone number corresponding to the control device 120.

For a specific example, the remote client system 132 may be actively executing or executing in the background of the client device 130. The control user of the control device 120 may call the client device 130 (e.g., dialing the mobile telephone number of the client device 130). The communication module 320 may receive or detect the incoming call or an indication of the incoming call from the control device 120. In some example embodiments, the client user of the client device 130 may answer the call to accept the control request from the control device 120. In other example embodiments, the communication module 320 may accept the control request unattended (e.g., without answering the call or other interaction with a user).

At operation 420, the authorization module 330 may determine an authorization for the control device 120. The authorization for the control device 120 may be used by the remote client system 132 and the remote control system 122 in a variety of ways. In an example embodiment, once the control device 120 is authorized, the control device 120 may send various command requests to the client device 130. In some example embodiments, different levels of authorization may be implemented for different actions or different users. For instance, particular command requests corresponding to various tasks may implement a higher level or different level of authorization than other command requests (e.g., a command request associated with modifying data on the client device 130 may implement a higher level of authorization than a command request associated with reading data from the client device 130). In an example embodiment, a read-only authorization may be employed that may provide the control device 120 read access to various resources of the client device 130 and prohibit various actions associated with writing or modifying data to the client device 130.

A variety of schemes and techniques may be employed to determine the authorization for the control device 120. In an example embodiment, the communication module 320 may request authorization data (e.g., a password as received from user input, biometric data as received from a biometric sensor of a device) from the control user by communicating an authorization request to the control device 120. In other example embodiments, the authorization data may be included with the control request. The control device 120, using the authorization module 230, may be operable to present a user interface configured to receive the authorization data from the control user and communicate the authorization data (e.g., using the communication module 220) to the client device 130. In some example embodiments, such communications may employ various encryption schemes to increase the security of the communication. In further example embodiments, the authorization module 330 may determine authorization based on location (e.g., as determined by a GPS component of a device). For instance, if the control device 120 is within a distance of the client device 130, the control device 120 may be authorized to remotely control the client device 130. In another instance, if the control device 120 is within a predefined boundary, the control device 120 may be authorized to remotely control the client device 130. The authorization module 330 may implement authorization in many other ways.

At operation 430, the communication module 320 may, based on the determined authorization, establish the data link via the cellular network 110 between the client device 130 and the control device 120 using the control device identifier. In an example embodiment, once the authorization module 330 has determined that the control device 120 is authorized (e.g., in operation 420), then the communication module 320 may establish the data link between the control device 120 and the client device 130. As described above, the data link may be established, for example, via the cellular network to allow for the coupling of the control device 120 and the client device 130 from distant physical locations. In further example embodiments, communication via the data link may be encrypted to increase security. A variety of encryption schemes and techniques may be employed by the remote control system 122 and the remote client system 132.

In some example embodiments, the data link may allow the exchange of information between the client device 130 and the control device 120 without an intermediate network node. Without the intermediate network node is intended to mean a peer-to-peer coupling that may employ various network devices that may be coupled to the control device 120 and the client device 130 in various configurations to facilitate the coupling of the control device 120 and the client device 130. While there may be intermediate networking equipment to facilitate the coupling between the client device 130 and the control device 120, there may not be an intermediate network node (e.g., a server) included in the peer-to-peer coupling. Thus, the data link may allow the exchange of information between the client device 130 and the control device 120 without being coupled to a particular common or central server (e.g., an intermediate network node) or a similar configuration. The peer-to-peer coupling may provide a more secure coupling as the communication between the devices may propagate to fewer network nodes reducing the risk of malicious interference.

The communication module 320 may establish the data link by employing a variety of techniques. In an example embodiment, the communication module 320 may identify the control device 120 using the control device identifier. As discussed above, in some example embodiments, the control device identifier may be included with the control request received from the control device 120. In other example embodiments, the control device identifier may be stored at the client device 130 and accessed by the communication module 320 (e.g., stored during a prior session of coupling between the control device 120 and the client device 130). In various example embodiments, the communication module 320 may determine various parameters for establishing the data link. For instance, the communication module 320 may identify an IP address of the control device 120 and a port to be used to establish the data link. In some example embodiments, the communication module 320 may store the parameters for establishing the data link at the client device 130 to be used in future sessions. Once the control device 120 is identified, the communication module 320 of the client device 130 may request connection with the control device 120. The communication module 220 of the control device 120 may then accept the connection from the client device 130.

In various alternative example embodiments, a server may be used, in various configurations, to facilitate establishing the data link, however, these are merely alternative embodiments and the data link may be established without using a server as described above. In alternative embodiment, the communication module 320 may identify parameters for establishing the data link by temporarily connecting to a common server. For instance, the control device 120 may communicate the control request to the client device 130 and the control device 120 may connect to the common server. In response to the client device 130 receiving the control request, the client device 130 may connect to the common server. While both the control device 120 and the client device 130 are connected to the common server, various parameters for establishing the data link may be exchange between the client device 130 and the control device 120 (e.g., an IP address for the control device 120 and port). After exchanging the parameters for establishing the data link, the control device 120 and the client device 130 may disconnect from the common server. The client device 130 may then establish the data link using the parameters obtained while connected to the common server.

In another example embodiment, the control device 120 may store the parameters for establishing the data link at a parameter server prior to communicating the control request. Subsequent to the client device 130 receiving the control request, the communication module 320 may retrieve the parameters for establishing the data link from the parameter server.

In still another alternative embodiment, the communication module 320 may retrieve various parameters for establishing the data link from a lookup server. For example, the communication module 320 may query the lookup server for various parameters for establishing the data link using the control device identifier (e.g., lookup connection parameters based on the control device identifier). Once the communication module 320 has retrieved the parameters for establishing the data link, the communication module 320 may establish the data link using the retrieved parameters.

In further example embodiments, once the data link between the client device 130 and the control device 120 has been established, the user interface module 310 of the client device 130 may present an indication that the client device 130 is currently being remotely controlled by the control device 120. In various example embodiments, the indication of control may be visual (e.g., a subtle change in icon color or icon design), audio (e.g., a soft periodic beep), tactile (e.g., a subtle and periodic vibration), other outputs, or a combination of outputs.

In still further example embodiments, the client user's ability to control the client device 130 may be inhibited while the control device 120 is remotely controlling the client device 130. In other words, the client user may be prevented from using the client device 130 while the client device 130 is being remotely controlled. In other example embodiments, both the client user and the control user may co-control the client device 130. In still other example embodiments, use of the client device 130 by the client user may be toggled on and off.

In yet further example embodiments, the communication module 320 and the communication module 220 may facilitate communication between the control user and the client user while the control device 120 may be remotely controlling the client device 130. For example, the communication may be vocal, textual, or another communication modality. The communication between the control user and the client user may assist the control user in training the client user or resolving a technical issue with the client device 130.

At operation 440, the communication module 320 may receive a command request from the control device 120 via the data link. In some example embodiments, the control request may be initiated by the control user of the control device 120. For instance, the control user may initiate the command request by interacting with a user interface configured to receive a command request. After the control user has initiated the command request, the communication module 220 of the remote control system 122 may communicate the command request to the remote client system 132 received by the communication module 320.

At operation 450, the task module 350 may perform a task based on the command request. For instance, the task module 350 may interpret the command request received from the control device 120 (e.g., in operation 440) to determine the interpreted command and execute the interpreted command at the client device 130. Many other tasks associated with the client device 130 may be performed by the task module 350.

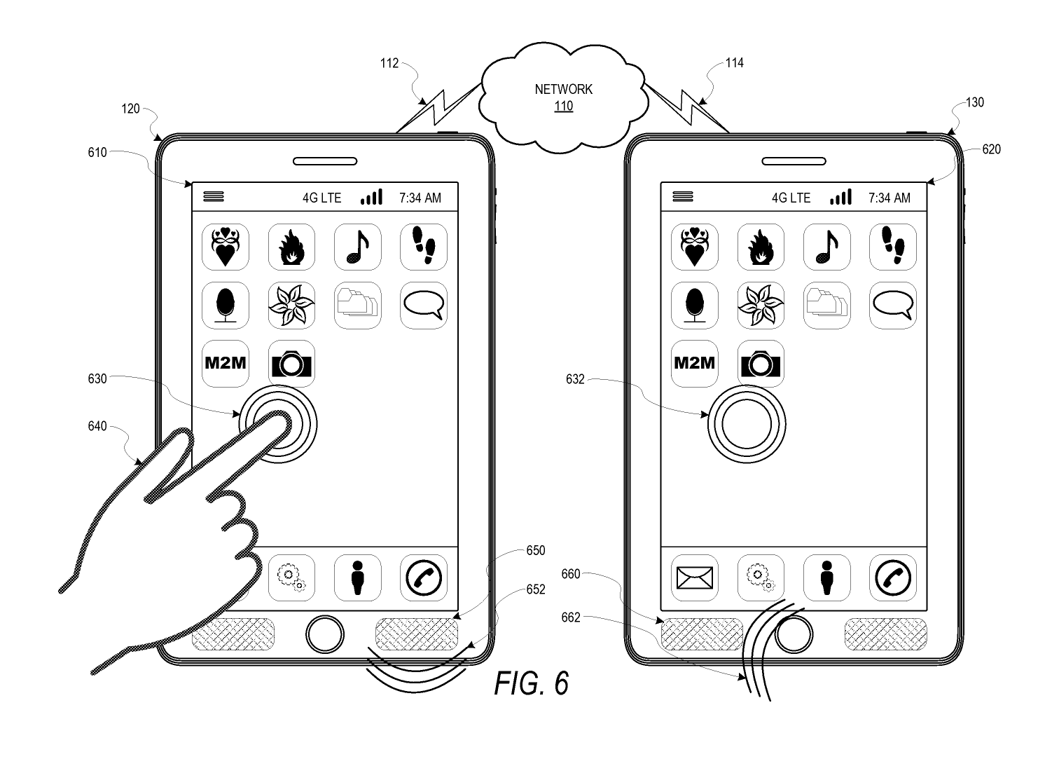

FIG. 5 is a flow diagram illustrating an example method 500 for remote control. The example method 500 illustrates the communication among the control user, the control device 120, the client device 130, and the client user, according to example embodiments. At operation 505, the control user may initiate the control request. For instance, the control user may interact with a user interface, provided by the user interface module 210, configured to provide an option to initiate remote control of a particular client device 130.

At operation 510, the communication module 220 of the remote control system 122 may communicate the control request to the client device 130. For example, the control request may be in the form of a text message, voice call, or other means of communication.

As described above, at operation 410, the client device 130 may receive the control request from the control device 120. For instance, the remote client system 132 may be executing in the background of the client device 130 and the communication module 320 may monitor incoming calls, text messages, or other messages. Upon receiving an indication of an incoming call, text message, or other message, the communication module 320 may determine that the control request has been received. In some example embodiments, the user interface module 310 may present a notification to the client user that the control request has been received.

Subsequent to receiving the control request, at operation 420, the authorization module 330 may determine an authorization for the control device 120. In some example embodiments, at operation 515 the user interface module 310 may present a user interface configured to provide an option to accept the control request from the control device 120 to the client user. The client user may select the option to allow the control device 120 to remotely control the client device 130. In other example embodiments, there may not be a client user or any user of the client device 130 included the example method 500. For instance, the control device 120 may remotely control a client device 130 that is not attended by a user.

In various example embodiments, operation 420 may include the authorization module 330 requesting the authorization data from the control device 120. The control device 120 may receive the request for the authorization data and, at operation 520, the authorization module 230 may request the authorization data from the control user (e.g., request the control user to enter a password). At operation 525, the control user may provide the authorization data. For example, the user interface module 210 of the control device 120 may present a user interface configured to receive the authorization data from the control user (e.g., presenting a user interface for a user to input a password as text). As discussed above, the authorization data may be a variety of data including passwords and biometric data (e.g., vocal, finger print, and so on). The communication of the authorization data may be encrypted to increase security. In other example embodiments, the authorization data may be included with the control request.

After determining the authorization for the control device 120, at operation 430, the communication module 320 may establish the data link via the cellular network with the control device 120. As discussed above, the data link between the control device 120 and the client device 130 may be established using a variety of schemes and techniques. At operation 530, the communication module 220 of the control device 120 may similarly facilitate establishing the data link.

Once the data link has been established, at operation 440, the communication module 320 of the client device 130 may receive the command request as described above. In particular, at operation 535, the control user may initiate the command request. For example, the control user may interact with a user interface presented by the user interface module 210 of the remote control system 122 to generate the command request. At operation 540, the communication module 220 may communicate the command request received from the control user to the client device 130. Subsequent to receiving the command request at the communication module 320 of the client device 130, at operation 450, the task module 350 of the client device 130 may perform the task based on the command request.

Although FIG. 5 shows one control device 120 and one client device 130, in other example embodiments, the control device 120 may remotely control multiple client devices. Similarly, in other example embodiments, multiple control devices may remotely control the client device 130.

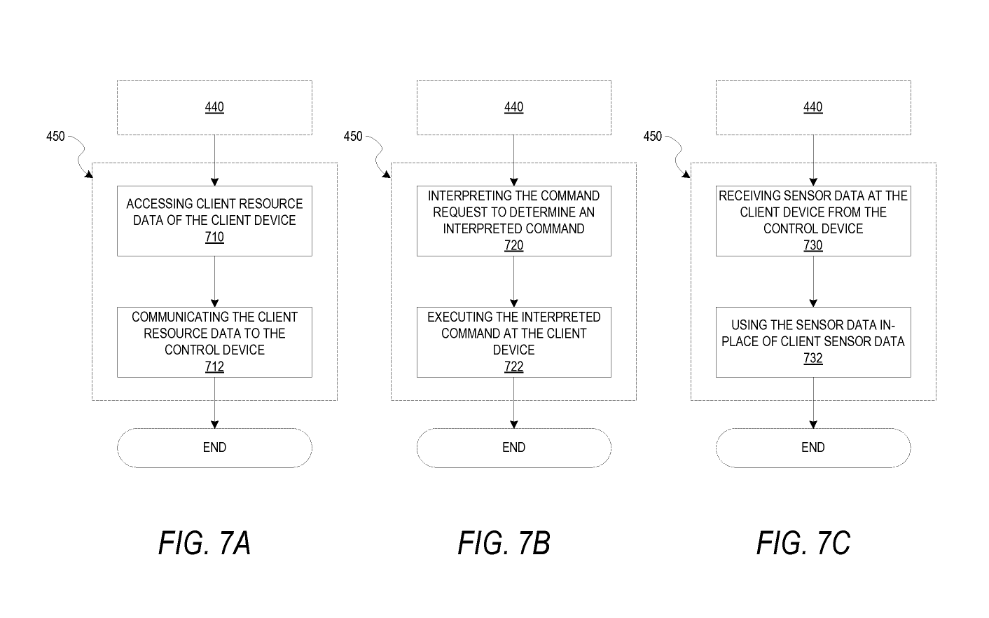

FIG. 6 illustrates example devices performing remote control, according to example embodiments. In this example, the control device 120 and the client device 130 may be smart phones, although in other examples the control device 120 and the client device 130 may be other mobile devices (e.g., a smart appliance). The control device 120 may include a display 610 operable to present interactive user interfaces to the control user. Similarly, the client device 130 may include a display 620 operable to present interactive user interfaces to the client user. For example, the control user may physically interact 640 with the display 610 by touch 630. The touch 630 may initiate the command request to be communicated to the client device 130. The control user may provide many other inputs to initiate the command request at the control device 130 (e.g., vocal, acceleration, location, textual).

The client device 130 may receive the command request and perform a task based on the command request. For example, the client device 130 may generate an emulated touch 632 that is similar to the touch 630 (e.g., the simulated touch 632 may be at a same location relative to the display 620, temporal features, and so forth of the touch 630). It will be appreciated that although FIG. 6 shows the client device 130 presenting the user interface, in other example embodiments the client device 130 may be unattended by a user and updating the user interface of the client device 130 may be optional.

Although FIG. 6 shows the control device 120 and the client device 130 being similar devices, the control device 120 and the client device 130 may not necessarily be the same or similar devices or running the same or similar operating systems. For instance, a cross device and cross platform command request may be implemented by interpreting the command request and performing a task with a similar intention or effect of the command request. In this way, the control device 120 may generate and communicate various command requests to various client devices 130 that are of different types running different operating systems.

FIG. 6 also shows an audio event 662 that may be captured by a sensor 660 (e.g., a microphone) of the client device 130. In an example embodiment, the audio event 662 may be captured by the client device 130 and communicated to the control device 120. The control device 120 may receive the sensor data and may output or otherwise present the sensor data to the control user. For instance, the control device 120 may include a speaker 650 that may output 652 the audio event 662 received at the client device 130. Although the example of audio has been discussed, many other sensors types and sensor data may be communicated from the client device 130 to the control device 120. In the case where the control device 120 is not equipped with a like output for the sensor data (e.g., audio data without a speaker for audio output) other representations of the sensor data may be presented to the control user (e.g., visually displaying a spectrogram, a magnitude reading). In some example embodiments, the sensor data received at the client device 130 may be communicated to the control device 120 by the communication module 320 as the sensor data is received at the client device 130. This may provide real-time or near real-time access to the sensor data received at the client device 130 to the control device 120. In this way, the control device 120 may monitor sensor data from various client devices 130 without the control device 120 being of the same kind or having the same or similar sensors as the client device 130.

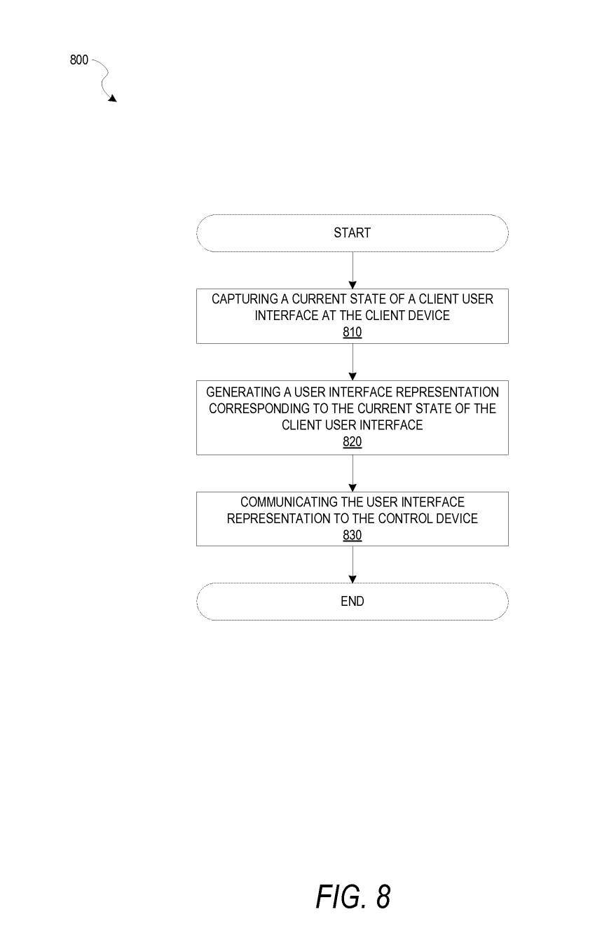

FIGS. 7A, 7B and 7C are flow diagrams illustrating various example remote control tasks, according to example embodiments. The operations discussed in FIGS. 7A, 7B and 7C may be performed by components of the remote client system 132 in operation 450 subsequent to operation 440. The client device 130 may perform a wide variety of task based on the command request. The following discussion merely provides non-limiting examples of such tasks.

FIG. 7A illustrates example operations for performing the task based on the command request. At operation 710, the resource module 340 may access resource data of the client device 130. For example, the resource data may include stored data (e.g., music files, contacts lists, web browsing history), sensor data or sensor signals (e.g., a microphone audio stream, a video stream from a video sensor), device settings, device maintenance data, externally coupled devices, externally coupled sensors, communication components (e.g., NFC components), and other device resources. In further example embodiments, resources coupled to the client device 130 may also be accessible to the resource module 340. For example, if the client device 130 is coupled to a server or otherwise connected to an external device, the resource module 340 may access the externally coupled device.

At operation 712, the communication module 320 may communicate the client resource data or signals to the control device 120. For example, the command request received by the client device 130 may indicate the intention of accessing a particular file stored on the client device 130. In response to the command request, the task module 350 may facilitate the resource module 340 to access the requested file and the communication module 320 to communicate the request file to the control device 120. In this way, the control device 120 may access the resource available to the resource module 340 on the client device 130.

FIG. 7B illustrates example operations for performing the task based on the command request. At operation 720, the task module 350 may interpret the command request to determine an interpreted command. For instance, the control device 120 and the client device 130 may be of different types running different operating systems. In this instance, the command request may not exactly translate into an executable command at the client device 130. The task module 350 may interpret the command request to determine the interpreted command that may be executed by the client device 130. The interpreted command may maintain the intention or effect of the command request and be executable on the client device 130. However, in some instances, the command request may be executable by the client device 130 without interpretation (e.g., command request communicated from a like device to a like device).

At operation 722, the task module 350 may execute the interpreted command at the client device 130. In some example embodiments, an acknowledgement of the execution of the interpreted command may be communicated to the control device 120 by the communication module 320.

FIG. 7C illustrates example operations for performing the task based on the command request. At operation 730, the communication module 320 may receive control sensor data (e.g., audio data, biometric data, video data, acceleration data) at the client device 130, via the data link, from the control device 120. The control sensor data may have been generated at the control device 120. For example, the control user may input a gesture or a touch (associated with a touch screen display) at the control device 120. The communication module 220 of the control device 120 may communicate the gesture or touch data may be communicated to the client device 130.

At operation 732, the task module 350 may use the control sensor data in-place of client sensor data. For instance, touch or gesture data may have been received at the operation 730 and the touch or gesture data may be used to emulate a like touch or gesture at the client device 130. In another example, if audio data is received at the operation 730, the audio data may be used as input in the client device 130. A wide variety of sensor data may be received at the operation 730 and used in-place of the client sensor data at the operation 732 (e.g., audio, tactile, accelerometer, gyroscope). Thus, sensor data may be remotely input into the client device 130.

In further example embodiments, the control user may be provided the option to toggle between the client device 130 using the sensor data from sensors at the client device 130 and the client device 130 using the sensor data from sensors at the control device 120. For instance, in some cases, the control user may desire the sensor data at the control device 120 to be used in-place of the sensor data at the client device 130.

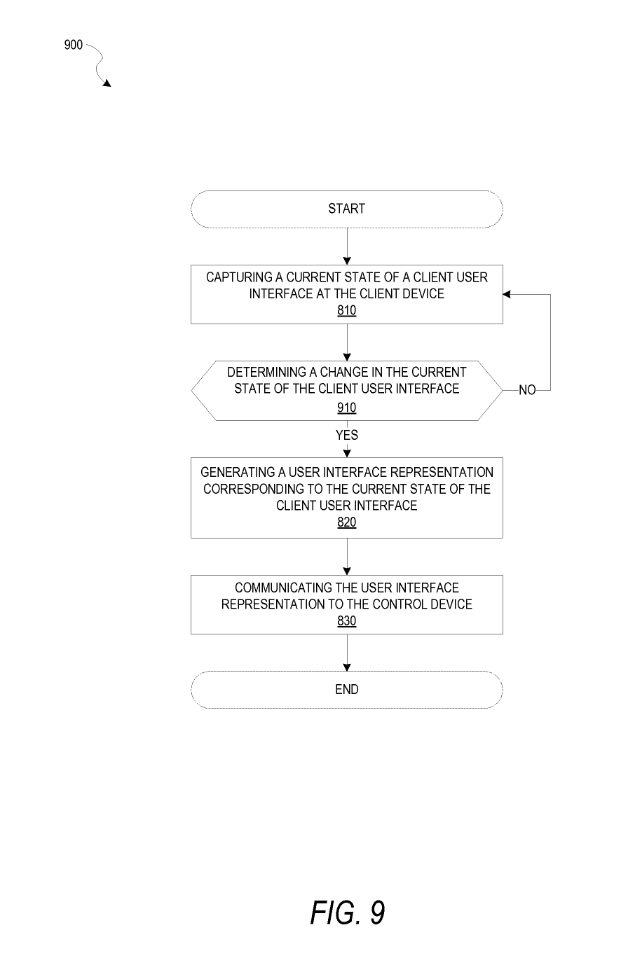

FIG. 8 is a flow diagram illustrating an example method 800 for communicating a user interface representation to the control device 120. The operations of the method 800 may be performed by components of the remote client system 132. At operation 810, the user interface module 310 may capture a current state of the client user interface at the client device 130. For instance, the client device 130 may be presenting the client user interface on a display 620 of the client device 130. In other instance, the client user interface may not be displayed, but may nonetheless have a current state. It will be appreciated that the term user interface as used herein is intended to include various forms of output such as visual, audio, tactile, and other output modalities. In some example embodiments, the current state of the client user interface may be captured by, for example, storing an image of the user interface. In other example embodiments, the current state of the client user interface may be captured by storing data that may be used to reconstruct the client user interface or a likeness of the client user interface (e.g., reducing the user interface to vector shapes).

At operation 820, the user interface module 310 may generate the user interface representation corresponding to the current state of the client user interface. Many different schemes and techniques may be employed to generate the user interface representation. In some example embodiments, the user interface representation may simply be an image of the current state of the client user interface (e.g., bitmap or compressed format such as Joint Photographic Experts Group (JPEG)). In this example embodiment, the image may be compressed or otherwise reduced to conserve memory resources (e.g., reduce image storage size by reducing image quality).

In other example embodiments, the user interface representation may be data that may be used to reconstruct the current state of the client user interface or a likeness of the current state of the client user interface. For instance, the user interface representation may be a list of user interface objects including object data associated with the user interface objects. The object data may, for example, include data such as the user interface object location (e.g., relative to the display), function, color, shape, and so on. The list of user interface objects and the object data may allow for the reconstruction of the client user interface or a likeness of the client user interface. In another instance, the client user interface may be represented by vectors rather than an image. In a specific example, if the current state of the client user interface is presenting a circle, an image, even in a compressed format, it may be an inefficient way to represent the client user interface. In this example, the user interface representation may be a vector shape of the circle (e.g., origin and radius of the circle). The vector representation may be more efficient than an image representation. An efficient representation is desirable to reduce storage space and network usage if the representation is to be transmitted. Although the above example relates to creating a vector version of the client user interface, many other schemes and techniques may be employed to generate the user interface representation.

At operation 830, the communication module 320 may communicate the user interface representation to the control device 120 via the data link. The control device 120 may present an interpreted user interface, based on the user interface representation, to the control user. For instance, if the user interface representation is simply an image of the current state of the client user interface, the user interface module 210 of the control device 120 may simply present the image to the control user. In another instance, if the user interface representation is a reduction of the current state of the client user interface (e.g., vector shape data), then the user interface module 210 of the control device 120 may reconstruct an output based on the user interface representation (the interpreted user interface) to be presented to the control user. In some instances, the reconstruction of the current state of the client user interface may only be an approximation or likeness of the client user interface.

In various example embodiments, the user interface module 210 of the control device 120 may interactively present the interpreted user interface such that the control user may provide, for example, input touches, gestures, or other forms of input in association with the interpreted user interface. These user inputs may generate command request to be communicated to the client device 130. Thus, in some example embodiments, the control user may interact with the interpreted user interface at the control device 120 as though the control user were interacting with the client user interface at the client device 130. The command request may be in association with the user interface representation.

In some example embodiments, the user interface representation corresponding to the current state of the client user interface maybe generated and communicated to the control device 120 at a time interval (e.g., every 3 seconds). The time interval may be user configurable. In other example embodiments, the time interval may be based, at least in part, on available bandwidth for transmission. The communication module 320 may determine the time interval for communicating the user interface representation based on the available bandwidth of the cellular network. For instance, the time interval may increase if there is sufficient bandwidth to allow for transmission. Similarly, the time interval may decrease to reduce the burden on the network 110 if there is insufficient bandwidth.

FIG. 9 is a flow diagram illustrating an example method 900 for communicating the user interface representation to the control device 120. The operations of method 900 may be performed by components of the remote client system 132. As discussed above, at the operation 810, the user interface module 310 may capture the current state of the client user interface at the client device 130.

At operation 910, the user interface module 310 may determine a change in the current state of the client user interface. For instance, the user interface module 310 may determine a change by comparing the current state of the client user interface with a past state of the client user interface. The user interface module 310 may determine that a change has occurred based on the comparison. In other instances, the user interface module 310 may determine a change or likely change in the client user interface based on an event occurring or detecting an event occurrence. For example, an event such as a message from the operating system or from an event from software executing on the client device 130 may cause the user interface module 310 to determine that a change in the user interface has occurred or likely has occurred. In this way, the user interface module 310 may determine a change in the client user interface without directly monitoring the client user interface.

Subsequent to the user interface module 310 determining a change in the current state of the client user interface, as discussed above, at operation 820, the user interface module 310 may generate the user interface representation corresponding to the current state of the client user interface.

At operation 830, the communication module 320 may communicate the user interface representation to the control device 120 via the data link. The control device 120 may present an interpreted user interface that may be based on the user interface representation to the control user.

In further example embodiments, the generating and communicating of the user interface representation may depend upon a combination of one or more of a change in the current state of the client user interface, a time interval, available transmission bandwidth, or other factors. For instance, a scheme may be implemented where a maximum number of user interface representations may be communicated within a time interval and the time interval may be adjusted according to available bandwidth. The scheme may further incorporate determining the change in the current state of the client user interface. In this instance, for example, the user interface representation may be generated and communicated to the control device 120 if there is a change in the current state of the client user interface and only at a maximum interval as determined by the bandwidth. Many other schemes may be implemented and the above is merely a non-limiting example.

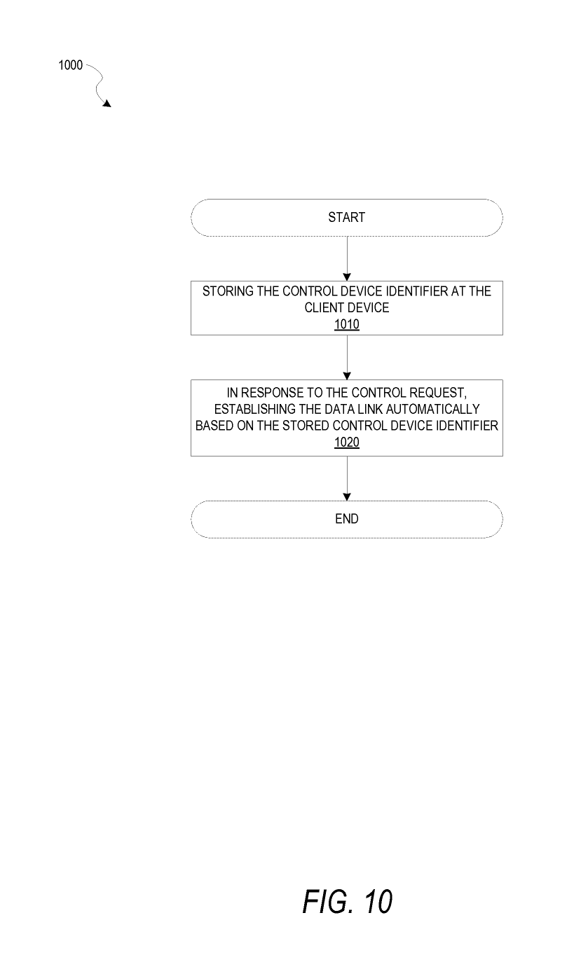

FIG. 10 is a flow diagram illustrating an example method 1000 for establishing the data link, according to example embodiments. The operations of method 1000 may be performed by components of the remote client system 132. At operation 1010, the authorization module 330 may store the control device identifier at the client device 130. In some example embodiments, connection data associated with the control device identifier may be stored along with the control device identifier. For example, if the control device identifier is a mobile telephone number and the data link has been successfully established in a past session, the mobile telephone number and connection parameters (e.g., IP address, port, and so on) may be stored to be used in the future by the client device 130.

At operation 1020, the communication module 320 may establish the data link automatically based on the stored control device identifier. For instance, the communication module 320 may accept the control request automatically by determining that the control request originated from a device designated to remotely control the client device 130 (e.g., a trusted list of control devices 120). In some example embodiments, the control device identifier, stored by the authorization module 330 at the operation 1010, may be designated by the client user to be automatically authorized to establish the data link.

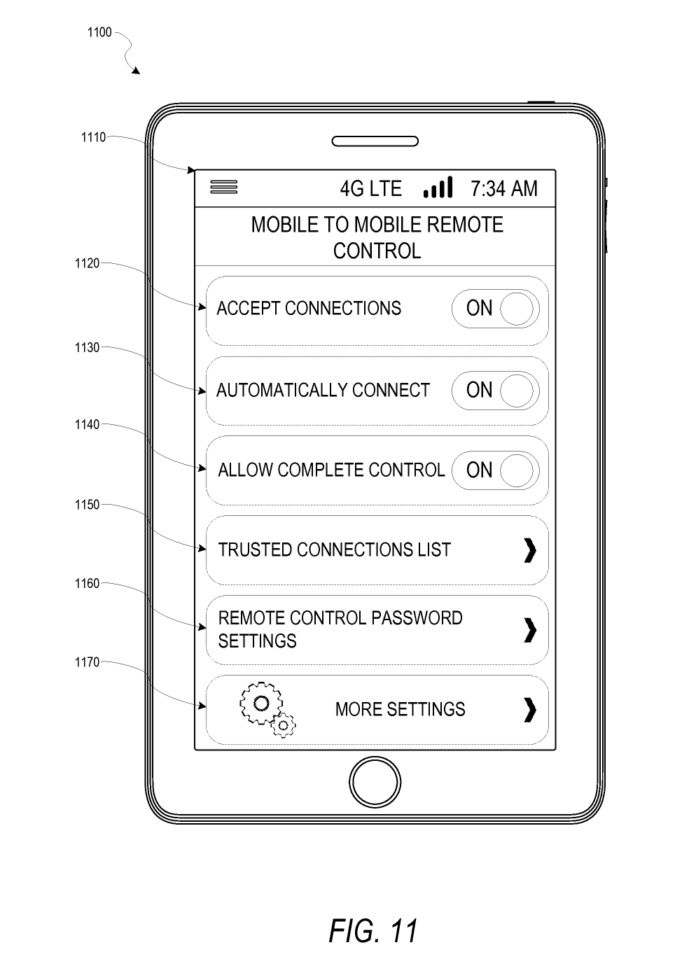

FIG. 11 illustrates an example user interface for presenting various example remote control options, according to example embodiments. The example client device 1100 may include a display 1110 operable to present interactive user interfaces to the client user. The display 1110 may display an example user interface for presenting various options to the user. User interface element 1120 may provide the client user an option to allow establishing the data link in response to the control request. User interface element 1130 may provide the client user an option to automatically establish the data link without prompting the client user for authorization. User interface element 1140 may provide the client user an option to allow complete control of the client device 130 by the control device 120. For example, if the user selects this option, the control device 120 may access available features and resources provided by the remote client system 132. User interface element 1150 may provide the user an option to allow automatic establishment of the data link with user-specified control devices 120 (e.g., specified using control device identifiers). User interface element 1160 may allow the user to specify authorization data to be provided by the control device 120. User element 1170 may provide additional options, settings, and configurations.

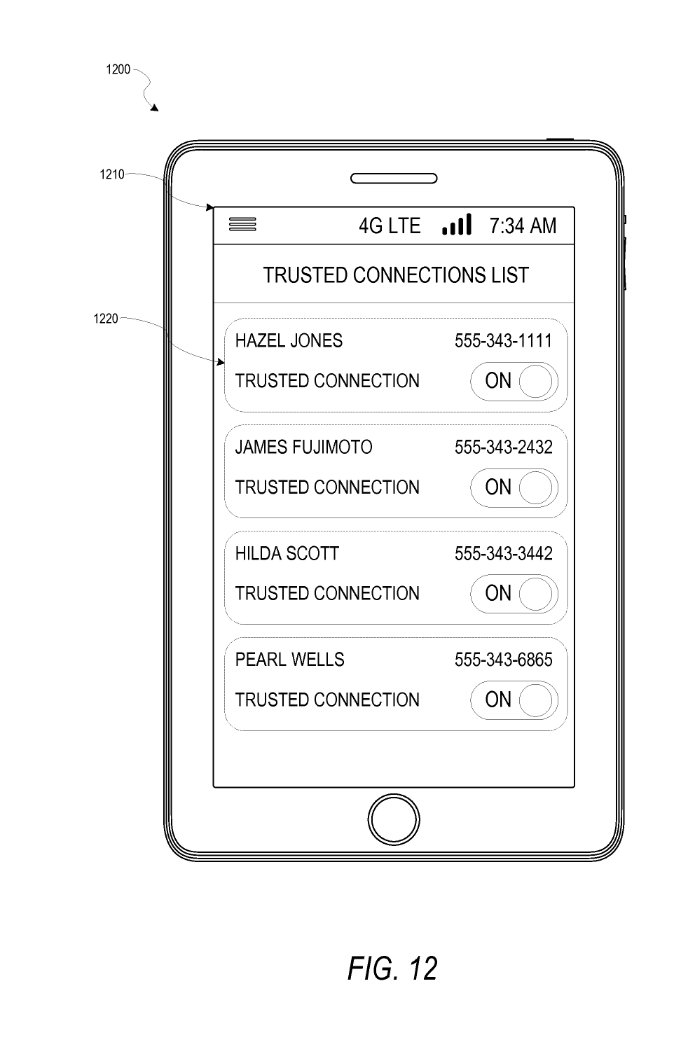

FIG. 12 illustrates an example user interface for presenting a trusted connections list, according to example embodiments. The example client device 1200 may include a display 1210 operable to present interactive user interfaces to the client user. The display 1210 may display an example user interface for presenting a trusted connection list 1220 to the client user. The trusted connection list 1220 may be a list of designated control device identifiers that may be designated to automatically establish a data link with the client device 130.

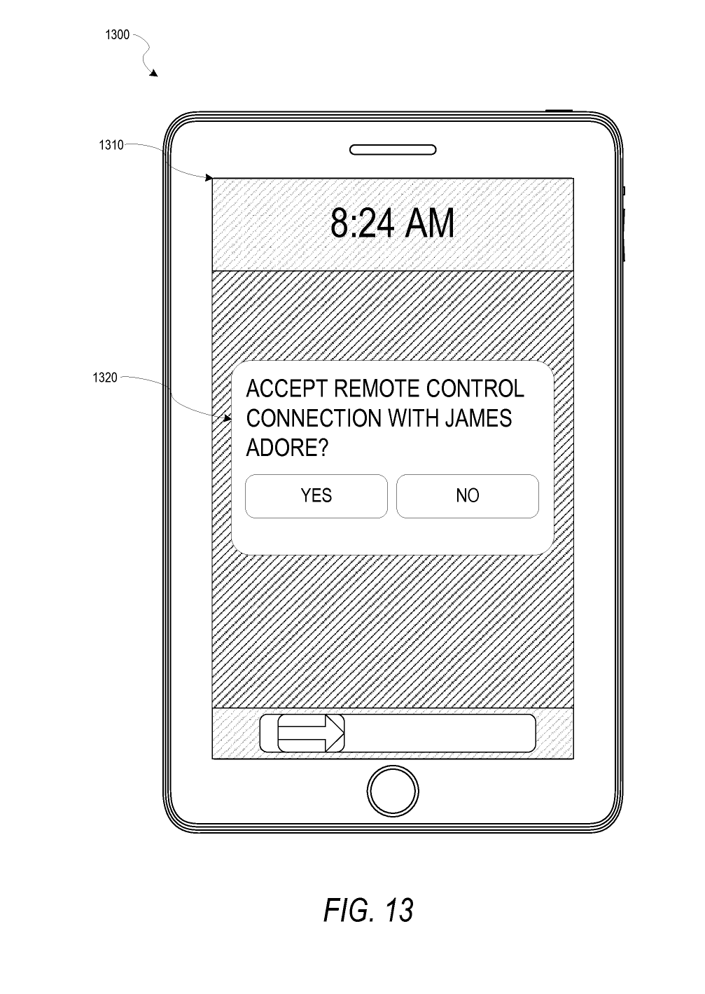

FIG. 13 illustrates an example user interface for presenting a connection notification, according to example embodiments. The example client device 1300 may include a display 1310 operable to present interactive user interfaces to the client user. The display 1310 may display an example user interface for presenting a connection notification 1320 to the client user. The connection notification 1320 may be presented to the client user upon the client device 130 receiving a control request. In some example embodiments, the client user may be provided an option to accept the control request or refuse the control request.

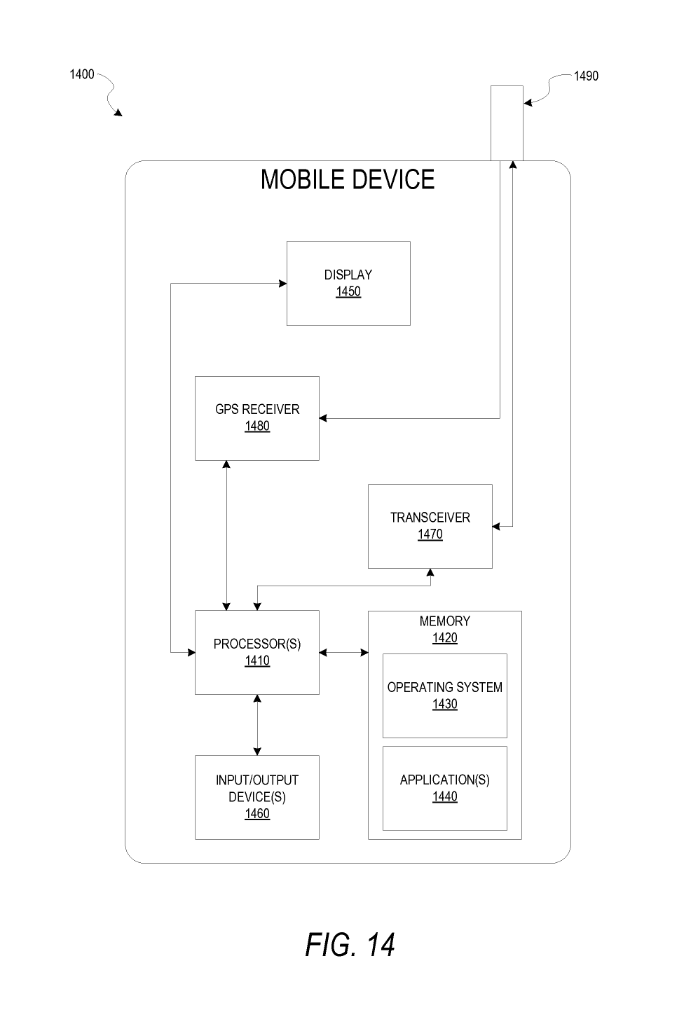

FIG. 14 is a block diagram illustrating a mobile device 1400, according to an example embodiment. The mobile device 1400 may include a processor 1410. The processor 1410 may be any of a variety of different types of commercially available processors suitable for mobile devices (e.g., an XScale architecture microprocessor, a Microprocessor without Interlocked Pipeline Stages (MIPS) architecture processor, or another type of processor). A memory 1420, such as a random access memory (RAM), a Flash memory, or other type of memory, is typically accessible to the processor 1410. The memory 1420 may be adapted to store an operating system (OS) 1430, as well as application programs 1440, such as a mobile location enabled application that may provide location based services (LBSs) to a user.

The processor 1410 may be coupled, either directly or via appropriate intermediary hardware, to a display 1450 and to one or more input/output (I/O) devices 1460, such as a keypad, a touch panel sensor, a microphone, and the like. Similarly, in some embodiments, the processor 1410 may be coupled to a transceiver 1470 that interfaces with an antenna 1490. The transceiver 1470 may be configured to both transmit and receive cellular network signals, wireless data signals, or other types of signals via the antenna 1490, depending on the nature of the mobile device 1400. In this manner, a connection with a network such as the network 110 of FIG. 1 may be established. Further, in some configurations, a GPS receiver 1480 may also make use of the antenna 1490 to receive GPS signals.

### Modules, Components, and Logic

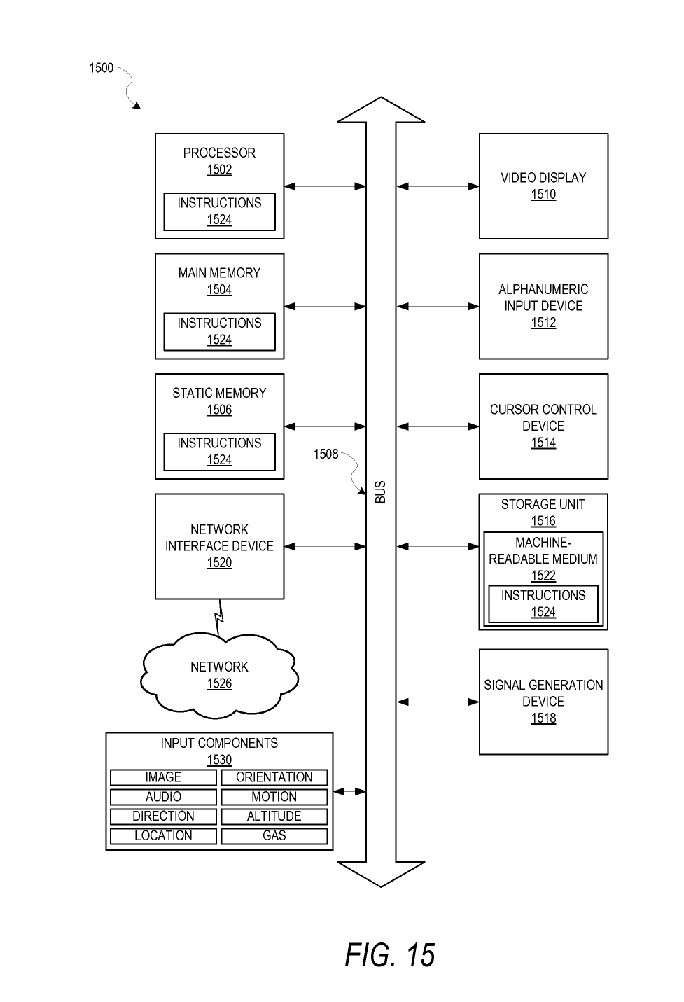

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1524 (e.g., software, a program, an application, an applet, an app, or other executable code) for causing the machine 1500 to perform any one or more of the methodologies discussed herein may be executed. In alternative embodiments, the machine 1500 operates as a standalone device or may be connected (e.g., networked) to other machines. In a networked deployment, the machine 1500 may operate in the capacity of a server machine or a client machine in a server-client network environment, or as a peer machine in a peer-to-peer (or distributed) network environment. The machine 1500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1524, sequentially or otherwise, that specify actions to be taken by that machine. Further, while only a single machine 1500 is illustrated, the term “machine” shall also be taken to include a collection of machines 1500 that individually or jointly execute the instructions 1524 to perform any one or more of the methodologies discussed herein.

The machine 1500 includes a processor 1502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1504, and a static memory 1506, which are configured to communicate with each other via a bus 1508. The machine 1500 may further include a video display 1510 (e.g., a plasma display panel (PDP), a light emitting diode (LED) display, a liquid crystal display (LCD), a projector, or a cathode ray tube (CRT)). The machine 1500 may also include an alphanumeric input device 1512 (e.g., a keyboard), a cursor control device 1514 (e.g., a mouse, a touchpad, a trackball, a joystick, a motion sensor, or other pointing instrument), a storage unit 1516, a signal generation device 1518 (e.g., a speaker), and a network interface device 1520.

The storage unit 1516 includes a machine-readable medium 1522 on which is stored the instructions 1524 embodying any one or more of the methodologies or functions described herein. The instructions 1524 may also reside, completely or at least partially, within the main memory 1504, within the static memory 1506, within the processor 1502 (e.g., within the processor's cache memory), or both, during execution thereof by the machine 1500. Accordingly, the main memory 1504, static memory 1506 and the processor 1502 may be considered as machine-readable media 1522. The instructions 1524 may be transmitted or received over a network 1526 via the network interface device 1520.

In some example embodiments, the machine 1500 may be a portable computing device, such as a smart phone or tablet computer, and have one or more additional input components 1530 (e.g., sensors or gauges). Examples of such input components 1530 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1522 able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e.g., a centralized or distributed database, or associated caches and servers) able to store instructions 1524. The term “machine-readable medium” shall also be taken to include any medium, or combination of multiple media, that is capable of storing instructions (e.g., instruction 1524) for execution by a machine (e.g., machine 1500), such that the instructions 1524, when executed by one or more processors of the machine 1500 (e.g., processor 1502), cause the machine 1500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 1522 is non-transitory in that it does not embody a propagating signal. However, labeling the machine-readable medium 1522 as “non-transitory” should not be construed to mean that the medium is incapable of movement; the medium should be considered as being transportable from one physical location to another. Additionally, since the machine-readable medium 1522 is tangible, the medium may be considered to be a machine-readable device.

The instructions 1524 may further be transmitted or received over a communications network 1526 using a transmission medium via the network interface device 1520 and utilizing any one of a number of well-known transfer protocols (e.g., hypertext transfer protocol (HTTP)). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 1524 for execution by the machine 1500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 1522 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 1502, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1502 that are temporarily configured (e.g., by software) or permanently configured to perform the relevant operations. Whether temporarily or permanently configured, such processors 1502 may constitute processor-implemented modules that operate to perform one or more operations or functions described herein. As used herein, “processor-implemented module” refers to a hardware module implemented using one or more processors 1502.

Similarly, the methods described herein may be at least partially processor-implemented, with a processor 1502 being an example of hardware. For example, at least some of the operations of a method may be performed by one or more processors 1502 or processor-implemented modules. Moreover, the one or more processors 1502 may also operate to support performance of the relevant operations in a “cloud computing” environment or as a “software as a service” (SaaS). For example, at least some of the operations may be performed by a group of computers (as examples of machines 1500 including processors 1502), with these operations being accessible via the network 1526 (e.g., the Internet) and via one or more appropriate interfaces (e.g., an application program interface (API)).

The performance of certain of the operations may be distributed among the one or more processors 1502, not only residing within a single machine 1500, but deployed across a number of machines 1500. In some example embodiments, the one or more processors 1502 or processor-implemented modules may be located in a single geographic location (e.g., within a home environment, an office environment, or a server farm). In other example embodiments, the one or more processors 1502 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
at least one processor of a machine;
a communication module to receive a control request at a client device from a control device, the control device and the client device being in communication with a network;
an authorization module to determine an authorization for the control device at the client device in response to receiving the control request;
based on the determined authorization, the communication module further to establish, using the at least one processor of the machine, a data link via the network between the client device and the control device by use of a control device identifier, the data link allowing an exchange of information between the client device and the control device without an intermediate network node;
the communication module further to receive a command request at the client device from the control device via the data link, the command request being initiated by a control user of the control device; and
a task module to perform a task at the client device based on the command request.

2. The system of claim 1, further comprising:
a user interface module to:
capture a current state of a client user interface at the client device; and
generate a user interface representation that corresponds to the current state of the client user interface;
the communication module further to communicate the user interface representation to the control device via the data link, the control device to present an interpreted user interface based on the user interface representation to the control user.

3. The system of claim 2, further comprising:
the user interface module is further to determine a change in the current state of the client user interface; and
based on the change, the communication module is further to communicate the user interface representation to the control device.

4. The system of claim 1, wherein the task module is further to:
interpret the command request to determine an interpreted command; and
execute the interpreted command at the client device.

5. A method comprising:
receiving a control request at a client device from a control device, the control device and the client device being in communication with a network;
determining an authorization for the control device at the client device in response to receiving the control request;
based on the determined authorization, establishing, using a processor of a machine, a data link via the network between the client device and the control device using a control device identifier, the data link allowing an exchange of information between the client device and the control device without an intermediate network node;
receiving a command request at the client device from the control device via the data link, the command request being initiated by a control user of the control device; and
performing a task at the client device based on the command request.

6. The method of claim 5, further comprising:
capturing a current state of a client user interface at the client device;
generating a user interface representation corresponding to the current state of the client user interface; and
communicating the user interface representation to the control device via the data link, the control device to present an interpreted user interface to the control user based on the user interface representation.

7. The method of claim 6, further comprising:
determining a change in the current state of the client user interface; and
based on the change, communicating the user interface representation to the control device.

8. The method of claim 5, further comprising:
interpreting the command request to determine an interpreted command; and
executing the interpreted command at the client device.

9. The method of claim 5, further comprising:
storing the control device identifier at the client device; and
in response to receiving the control request, automatically establishing the data link based on the stored control device identifier.

10. The method of claim 5, further comprising:
accessing client resource data of the client device; and
communicating, via the data link, the client resource data to the control device.

11. The method of claim 10, wherein the client resource data includes sensor data received from sensors at the client device.

12. The method of claim 11, further comprising:
communicating the sensor data to the control device as it is received at the client device.

13. The method of claim 5, further comprising:
receiving control sensor data at the client device via the data link from the control device, the control sensor data being generated by the control device; and
using the control sensor data in-place of client sensor data.

14. The method of claim 5, wherein the control request is received via a text message communicated from the control device to the client device.

15. The method of claim 5, wherein the control request is received via an incoming call at the client device from the control device.

16. The method of claim 5, wherein the authorization is determined, at least in part, based on authorization data received from the control user at the control device.

17. The method of claim 5, further comprising:
presenting an option to authorize the control device to a client user at the client device;
receiving a selection of the option to authorize the control device from the client user; and
determining the authorization based on the received selection of the option to authorize the control device.

18. The method of claim 5, wherein the control request includes the control device identifier.

19. The method of claim 5, wherein the network is a cellular network.

20. A machine readable medium not having any transitory signals and storing instructions that, when executed by at least one processor of a machine, cause the machine to perform operations comprising:
receiving a control request at a client device from a control device, the control device and the client device being in communication with a network;
determining an authorization for the control device at the client device in response to receiving the control request;
based on the determined authorization, establishing a data link via the network between the client device and the control device using a control device identifier, the data link allowing an exchange of information between the client device and the control device without an intermediate network node;
receiving a command request at the client device from the control device via the data link, the command request being initiated by a control user of the control device; and
performing a task at the client device based on the command request.
